(19) United States
(12) Patent Application Publication
(10) Pub. No.: US 2022/0083459 A1
(43) Pub. Date: Mar. 17, 2022

(54) Verification Method of Managing Software Verification and Verification System Utilizing Same

(71) Applicant: Realtek Semiconductor Corp., HsinChu (TW)

(72) Inventors: Chun-Cheng Liu, HsinChu (TW); Cheng-Hao Li, HsinChu (TW); Shih-Jan Wei, HsinChu (TW)

(21) Appl. No.: 17/198,195

(22) Filed: Mar. 10, 2021

(30) Foreign Application Priority Data
Sep. 17, 2020 (TW) 109132102

(51) Int. Cl. G06F 11/36; G06F 8/41

(52) U.S. Cl. CPC G06F 11/3688; G06F 11/3664; G06F 8/41

(57) ABSTRACT

A verification system includes a local server, a plurality of verification platforms and a main server. A verification method includes the local server receiving program code to compile the same into a verification image, the local server selecting a verification platform from the plurality of verification platforms according to the type of the program code, the local server programming the verification image into the selected verification platform, the select platform performing a set of tests on the verification image to generate a verification report, and the main server generating an updated image according to the verification report.

### CROSS REFERENCE TO RELATED APPLICATION

This non-provisional application claims priority of Taiwan patent application No. 109132102, filed on 17 Sep. 2020, included herein by reference in its entirety.

### BACKGROUND OF THE INVENTION

### 1. Field of the Invention

The present invention relates to software verification, and in particular, to a verification system providing software verification and a verification method of the verification system.

### 2. Description of the Prior Art

Software verification is a process for use in software engineering to ensure code quality and functionality. After program code is completed, a software developer may submit the program code, write corresponding test program code and/or assign compiler parameters for various types of verifications. The various types of verifications such as format verifications, quality verifications, compilation verifications and basic function verifications are often required to be verified manually and separately, and are required to be set in various packages and executed manually, resulting in low verification efficiency.

### SUMMARY OF THE INVENTION

According to an embodiment of the invention, a verification system includes a local server, a plurality of verification platforms and a main server. A verification method for use in the verification system includes the local server receiving program code to compile the program code into a verification image, the local server selecting a verification platform from the plurality of verification platforms according to the type of the program code, the local server writing the verification image into the selected verification platform, the selected verification platform performing a set of tests on the verification image to generate a verification report, and the main server generating an updated image according to the verification report.

According to another embodiment of the invention, a verification system includes a local server, a plurality of verification platforms and a main server. One of the plurality of verification platforms is configured to perform a set of tests on a verification image to generate a verification report. The local server is coupled to the verification platforms and is configured to receive program code to compile the program code into the verification image, select the verification platform from the plurality of verification platforms according to the type of the program code, and write the verification image into the verification platform. The main server is coupled to the plurality of verification platforms and is configured to generate an updated image according to the verification report.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a verification system according to an embodiment of the invention.

FIG. 2 is a block diagram of the verification platform in FIG. 1.

FIG. 3 is a block diagram of an exemplary local server in FIG. 1.

FIG. 4 is a block diagram of another exemplary processor in FIG. 1.

FIG. 5 is a flowchart of a verification method of the verification system in FIG. 1.

FIG. 6 is a flowchart of another verification method of the verification system in FIG. 1.

### DETAILED DESCRIPTION

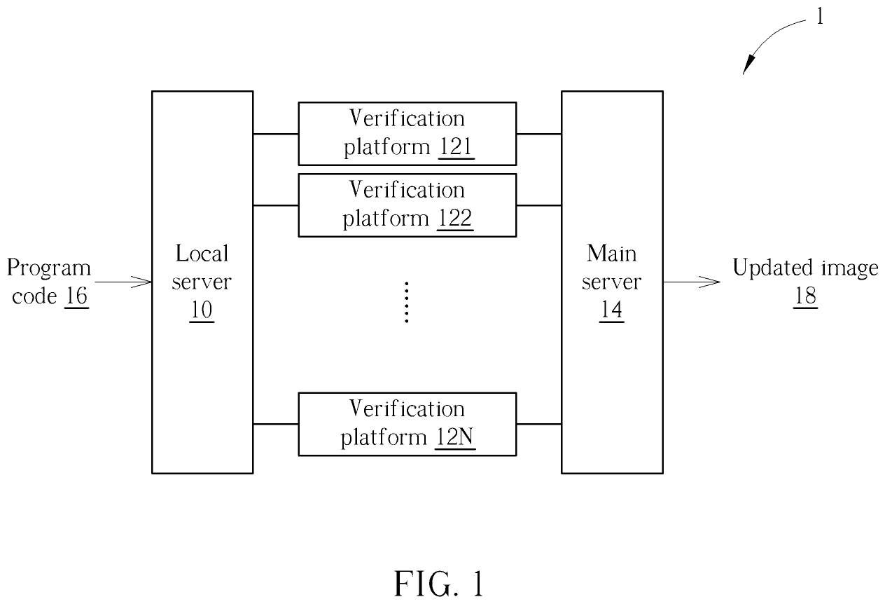

FIG. 1 is a block diagram of a verification system 1 according to an embodiment of the invention. The verification system 1 is an expandable and automated software verification system, and may select an appropriate verification platform according to the type of program code 16 to pre-verify the program code 16. After the program code 16 passes the verification, the program code 16 may be integrated into other pieces of verified program code to generate an updated image 18 (i.e. disk image such as ISO). If the program code 16 fails the verification, the verification system 1 may notify the submitter of the program code 16 and the person responsible for the project. The program code 16 may be a low-level patch file such as a driver patch file, or a high-level software patch file such as an android application package (APK) patch file. The updated image 18 may be an executable file. The verification system 1 may include a plurality of verification platforms, and may assign the plurality of verification platforms to various types of the program code 16, thereby implementing verifications in a multi-pipeline and multi-test manner, and providing efficient test assignment and verification platform management.

The verification system 1 may include a local server 10, a plurality of verification platforms 121-12N, and a main server 14, where N may be, but is not limited to, an integer greater than 2 and may represent the next digit after the number 12. The local server 10 is coupled to the verification platforms 121-12N and the verification platforms 121-12N are coupled to the main server 14.

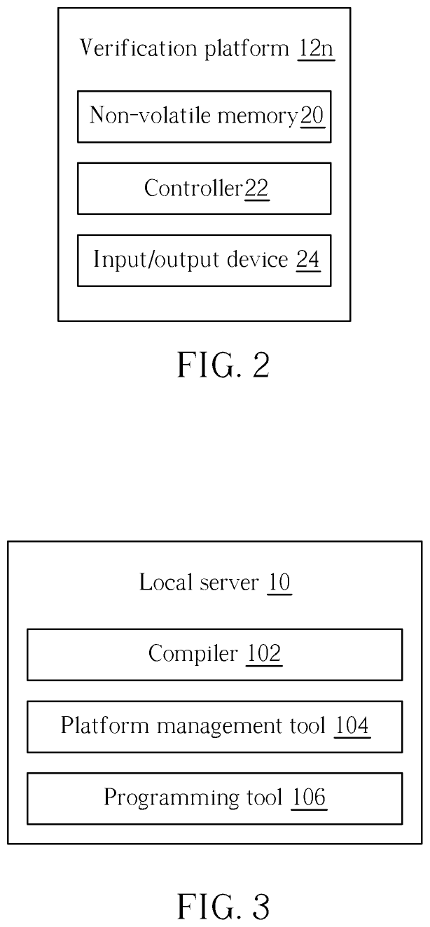

A verification environment may be preset in each of the verification platforms 121-12N to perform a set of tests of a respective verification type thereof, where the verification type may be associated with an application and/or a protocol. For example, the verification type may be associated with a low-level function of a TV application such as Android kernel program code, and the verification type may be associated with a high-level function of the TV application such as an Android service program code, and the verification type may be associated with a low-level function of a wireless network application such as a wireless network driver. The verification environment may include parameters, software and hardware, e.g., parameters, software, and hardware for testing a TV application. FIG. 2 is a block diagram of the verification platform 12n, n being a positive integer less than or equal to N (i.e., n=1, 2, 3, . . . , N). The verification platform 12n may be an embedded system including a non-volatile memory 20, a controller 22 and an input/output device 24. The non-volatile memory 20 may be an embedded multimedia card (eMMC). The controller 22 may be a processor, a field-programmable gate array (FPGA), an application-specific integrated circuit (ASIC), or a combination thereof. The input/output devices 24 of respective verification platforms 121-12N may be identical or different. For example, the input/output device 24 of the verification platform 121 may be a television tuner, the input/output device 24 of the verification platform 122 may be a wireless network, and the input/output device 24 of the verification platform 12N may be a specific input/output device for use in a set of tests of a specific verification type. The non-volatile memory 20 may store verification images, test parameters and test software. The controller 22 may load the verification images, test parameters and test software from the non-volatile memory 20 after booting, and control the input/output device 24 according to the test parameters and test software to apply a set of tests to the verification image to generate a verification report. The verification platforms 121-12N may be expanded based on actual requirements.

The user may submit the program code 16 to the local server 10 via user interface software of the local server 10. The local server 10 may receive the program code 16 and select at least one verification platform from the verification platforms 121-12N to verify the function of the program code 16. FIG. 3 is a block diagram of an exemplary local server 10. The local server 10 may include a compiler 102, a platform management tool 104 and a programming tool 106. The compiler 102 may compile the program code 16 into a verification image according to the programming language of the program code 16, and the verification image may be an executable file. The compiler 102 may be a GNU compiler set or other programming language compilers. The platform management tool 104 may select the verification platform from the plurality of verification platforms 121-12N according to the type of the program code 16. The type of the program code 16 may be associated with an application and/or a protocol. For example, when the program code 16 is Android core program code, the type thereof may be associated with a physical layer of a TV application; when the program code 16 is an Android service program, the type thereof may be associated with an upper layer of the TV application; when the program code 16 is a wireless network driver, the type thereof may be associated with a physical layer of a wireless network application. In some embodiments, the type of the program code 16 may be recorded in the comment section of the program code 16. In other embodiments, when a user uploads the program code 16 to the local server 10, the user may also enter the type of the program code 16 into user interface software of the local server 10. In some embodiments, the platform management tool 104 may select the verification platform according to the type of the program code 16 and the verification types corresponding to the plurality of verification platforms 121-12N. For example, the platform management tool 104 may match the type of the program code 16 to the verification types corresponding to the verification platforms 121-12N. When the type of the program code 16 matches a verification type corresponding to a verification platform 12p, the platform management tool 104 may select the verification platform 12p as the verification platform, p being a positive integer less than or equal to N. In other embodiments, the platform management tool 104 may select the verification platform according to the type of the program code 16, and the verification types and operating schedules corresponding to the plurality of verification platforms 121-12N. For example, the platform management tool 104 may match the type of the program code 16 to the verification types corresponding to the verification platforms 121-12N. When the type of the program code 16 matches verification types corresponding to verification platforms 12p and 12q, the platform management tool 104 may select one from the verification platform 12p and 12q that is more flexible or available in the operating schedule to be the verification platform, e.g., selecting the available verification platform 12p to be the verification platform, q being a positive integer less than or equal to N, and q being not equal to p. The programming tool 106 may acquire the verification image from the compiler 102 and write the verification image into the selected verification platform. The platform management tool 104 and the programming tool 106 may be implemented by software, hardware, or a combination thereof.

The selected verification platform may perform a set of tests of the matching verification type on the verification image to generate a verification report, and write the verification report into a database in the main server 14. For example, when the verification type is a TV application, a set of tests of the verification type may include a TV sweep test for a specific country, a TV channel switching test for the specific country, a picture quality test, a booting test, an operating environment test, a TV service test and other tests, and the verification report may include results of each test in the set of tests. In some embodiments, the local server 10 may also write the compilation result into the verification report in the database of the main server 14. In some embodiments, the main server 14 may compute a verification score of the program code 16 according to the verification report in the database. When the program code 16 passes the compilation or the set of tests, the main server 14 may increase the verification score, and the verification system 1 may continue with the subsequent processes; when the program code 16 fails the compilation or fails a test in the set of tests, the main server 14 may reduce the verification score, and the verification system 1 may stop the subsequent processes and notify the submitter of the program code 16 and the person responsible for the project may check this matter. For example, if the program code 16 is compiled successfully, the main server 14 may increase the verification score by 1 point (the score only serves as an example but not a limitation, and the same is applicable to the following examples), the local server 10 and the selected verification platform may continue with the subsequent verification platform selection process and test process; if the program code 16 is failed to compile, the main server 14 may deduct the verification score by 1 point, and the local server 10 may stop the subsequent verification platform selection process and test process. The local server 10 may read the verification report or the verification score from the main server 14. When the verification report indicates that the program code 16 has successfully passed all the tests or the program code 16 took a full verification score, the local server 10 may update the program code 16 to the main server 14, and the main server 14 may generate an updated image file 18 according to the program code 16; when the verification report indicates that the program code 16 has failed one or more tests or the program code 16 failed to achieve the full verification score, the local server 10 may not update the program code 16 to the main server 14 and may notify the submitter of the program code 16 and the person responsible for the project may check this matter, and the main server 14 may generate an updated image file 18 according to the program code previously passed the set of tests. A plurality of pieces of verified program code may be stored in the main server 14, and each piece of verified program code may be associated with identical or different applications or protocols. In some embodiments, when the verification report indicates that the program code 16 has successfully passed the set of tests, the main server 14 may generate the updated image 18 according to the program code 16 and other pieces of verified program code. The other verified program code and program code 16 may be associated with different applications or protocols.

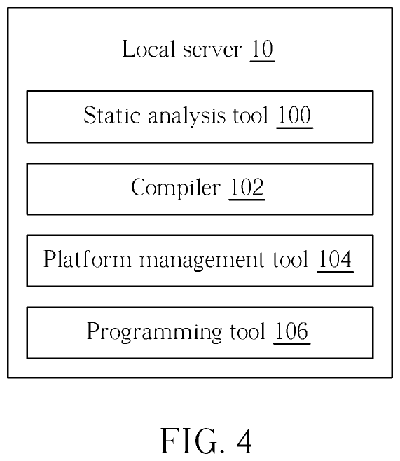

FIG. 4 is a block diagram of another exemplary local server 10. The local server 10 in FIG. 4 is different from that in FIG. 3 in that the local server 10 in FIG. 4 further includes a static analysis tool 100. The static analysis tool 100 will be explained as follows. The static analysis tool 100 may receive the program code 16 to determine whether the program code 16 conforms to a set of programming rules prior to a compilation of the program code 16, thereby ensuring the code quality of the program code 16. For example, the set of programming rules may include programming language comment rules, rules for memory loss, unused variables, unused functions, out-of-bound variables, C language syntax rules, Java syntax rules, syntax rules of other programming languages, coding style rules and other expandable programming rules. The programming rules may be expanded according to actual needs. The static analysis tool 100 may write the determination result of each programming rule into the verification report in the database of the main server 14. When the program code 16 conforms to all rules in the set of programming rules, the main server 14 may increase the verification score, and the verification system 1 may continue with the subsequent processes; when the program code 16 fails to conform to one or more rules of the set of programming rules, the main server 14 may deduct the verification score, and the verification system 1 may stop the subsequent processes and notify the submitter of the program code 16 and the person responsible for the project to check this matter. For example, if the program code 16 conforms to the comment rules of the programming language, the main server 14 may increase the verification score by 1 point, and the compiler 102 may continue to compile the program code 16 into a verification image; if the program code 16 fails to conform to the comment rules of the programming language, the main server 14 may deduct the verification score by 1 point, and the compiler 102 may stop compiling the program code 16 into the verification image. The static analysis tool 100 may be implemented by software, hardware, or a combination thereof.

The verification system 1 may assign corresponding verification platforms to perform different tests according to the type of the program code 16, realizing multi-pipeline and multi-test verification, and providing efficient test management and verification platform management. In addition, the verification system 1 may further conduct a verification process of programming rules via the static analysis tool 100 in the local server 10 to ensure the code quality of the program code 16.

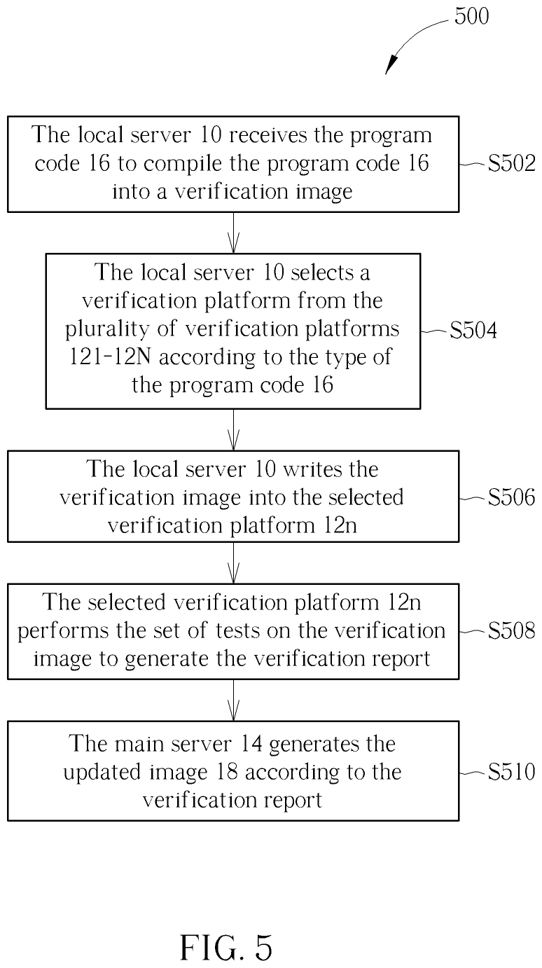

FIG. 5 is a flowchart of a verification method 500 of the verification system 1. The verification method 500 includes Steps S502-S510 and is used to select a verification platform according to the type of the program code, so as to generate a corresponding verification report, and to generate an updated image 18 according to the verification report. Any reasonable step change or adjustment is within the scope of the disclosure. Steps S502-S510 are detailed as follows:

Step S502: The local server 10 receives the program code 16 to compile the program code 16 into a verification image;

Step S504: The local server 10 selects a verification platform from the plurality of verification platforms 121-12N according to the type of the program code 16;

Step S506: The local server 10 writes the verification image into the selected verification platform 12n;

Step S508: The selected verification platform 12n performs the set of tests on the verification image to generate the verification report;

Step S510: The main server 14 generates the updated image 18 according to the verification report.

The explanation for Steps S502-S510 has been provided in the preceding paragraphs, and will be omitted here for brevity. The verification method 500 assigns verification platforms according to the type of the program code 16 to perform corresponding tests, realizing multi-pipeline and multi-test task verifications, and providing efficient test management and verification platform management.

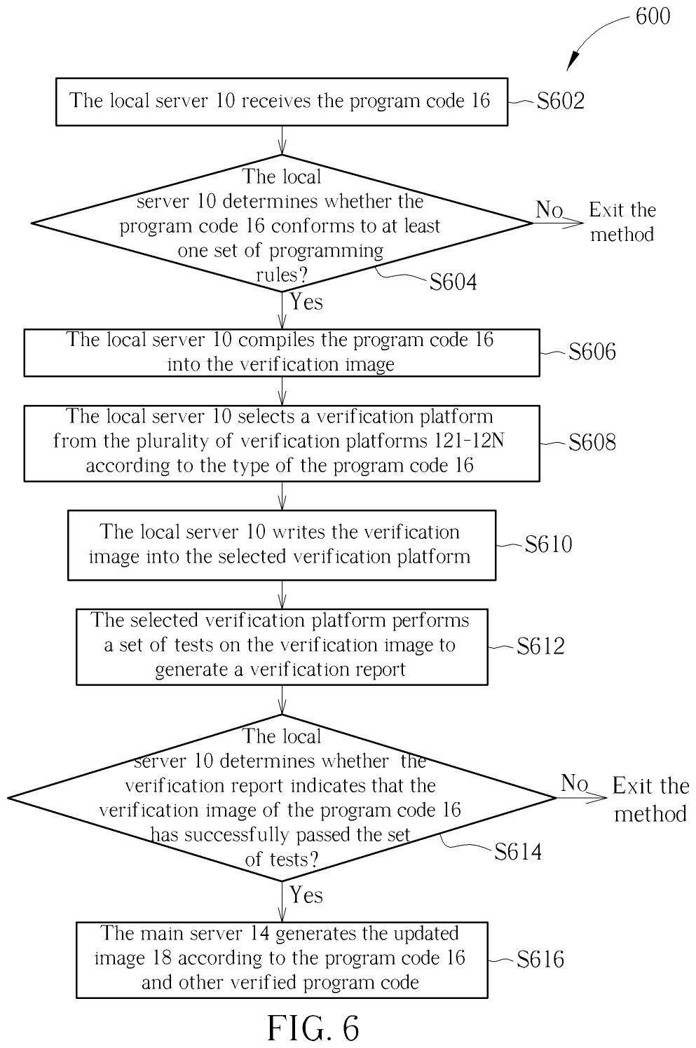

FIG. 6 is a flowchart of another verification method 600 of the verification system 1. The verification method 600 includes Steps S602-S616, where Steps S602 and S604 are used to check whether the program code 16 conforms to the programming rules before the program code 16 is compiled into the verification image; Steps S606-S616 are used to compile the program code 16 into the verification image, select a verification platform according to the type of program code 16 to verify the verification image and to generate a verification report, and generate an updated image 18 according to the verification report. Any reasonable step change or adjustment is within the scope of the disclosure. Steps S602-S616 are detailed as follows:

Step S602: The local server 10 receives the program code 16;

Step S604: The local server 10 determines whether the program code 16 conforms to at least one set of programming rules. If the determination result shows YES, proceed to Step S606; if the determination result shows NO, exit the verification method 600;

Step S606: The local server 10 compiles the program code 16 into the verification image;

Step S608: The local server 10 selects a verification platform from the plurality of verification platforms 121-12N according to the type of the program code 16;

Step S610: The local server 10 writes the verification image into the selected verification platform;

Step S612: The selected verification platform performs a set of tests on the verification image to generate a verification report;

Step S614: The local server 10 determines whether the verification report indicates that the verification image of the program code 16 has successfully passed the set of tests. If the determination result shows YES, proceed to Step S616; if the determination result shows NO, exit the verification method 600;

Step S616: The main server 14 generates the updated image 18 according to the program code 16 and other verified program code.

The explanation for Steps S602-S616 has been provided in the preceding paragraphs, and will be omitted here for brevity. The verification method 600 integrates the verification procedures of the programming rules before the compilation and the verification procedures of the verification platform after the compilation to ensure the program code quality and functionalities of the program code 16, realizing the multi-pipelines and multi-test verifications, and providing efficient test management and verification platform management.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A verification method applicable to a verification system, the verification system comprising a local server, a plurality of verification platforms and a main server, and the verification method comprising:
receiving, by the local server, program code to compile the program code into a verification image;
selecting, by the local server, a verification platform from the plurality of verification platforms according to a type of the program code;
, by the local server, the verification image into the selected verification platform;
performing, by the selected verification platform, a set of tests on the verification image to generate a verification report; and
generating, by the main server, an updated image according to the verification report.

2. The verification method of claim 1, wherein the local server receiving the program code to compile the program code into the verification image comprises:
determining whether the program code conforms to a set of programming rules; and
if it is determined that the program code conforms to the set of programming rules, the local server compiling the program code into the verification image.

3. The verification method of claim 1, wherein the local server selecting the verification platform from the plurality of verification platforms according to the type of the program code comprises:
selecting, by the local server, the verification platform according to the type of the program code and verification types corresponding to the verification platforms.

4. The verification method of claim 3, wherein the verification type is associated with a protocol or an application.

5. The verification method of claim 1, wherein the type of the program code is associated with a protocol or an application.

6. The verification method of claim 1, wherein the local server selecting the verification platform from the plurality of verification platforms according to the type of the program code comprises:
selecting, by the local server, the verification platform according to the type of the program code, and verification types and operating schedules corresponding to the verification platforms.

7. The verification method of claim 6, wherein the verification type is associated with a protocol or an application.

8. The verification method of claim 1, wherein the main server generating the updated image according to the verification report comprises:
generating, by the main server, the updated image according to the program code and other verified program code when the verification report indicates that the program code has successfully passed the set of tests.

9. A verification system comprising:
a plurality of verification platforms, one of the plurality of verification platforms being configured to perform a set of tests on a verification image to generate a verification report;
a local server coupled to the verification platforms and configured to:
receive program code to compile the program code into the verification image;
select the verification platform from the plurality of verification platforms according to a type of the program code; and
write the verification image into the verification platform; and
a main server coupled to the plurality of verification platforms and configured to generate an updated image according to the verification report.

10. The verification system of claim 9, wherein:
the local server determines whether the program code conforms to a set of programming rules, and if it is determined that the program code conforms to the set of programming rules, the local server compiles the program code into the verification image.

11. The verification system of claim 9, wherein:
the local server selects the verification platform according to the type of the program code and verification types corresponding to the verification platforms.

12. The verification system of claim 11, wherein the verification type is associated with a protocol or an application.

13. The verification system of claim 9, wherein the type of the program code is associated with a protocol or an application.

14. The verification system of claim 9, wherein:
the local server selects the verification platform according to the type of the program code, and verification types and operating schedules corresponding to the verification platforms.

15. The verification system of claim 14, wherein the verification type is associated with a protocol or an application.

16. The verification system of claim 9, wherein:
when the verification report indicates that the program code has successfully passed the set of tests, the main server generates the updated image according to the program code and other verified program code.
